(19) United States
(12) Patent Application Publication
(10) Pub. No.: US 2013/0319376 A1
(43) Pub. Date: Dec. 5, 2013

(54) Fuel Injection System for Diesel Engines with Compression Ignition

(71) Applicant: ABB Turbo Systems AG, Baden (CH)

(72) Inventors: Christoph MATHEY, Fislisbach (CH); Paolo TREMULI, Ennetbaden (CH)

(21) Appl. No.: 13/910,247

(22) Filed: Jun. 5, 2013

(30) Foreign Application Priority Data
Jun. 5, 2012 (DE) 10 2012 011 149.5

(51) Int. Cl. F02D 41/40

(52) U.S. Cl. CPC F02D 41/402
USPC 123/472

(57) ABSTRACT

In a fuel injection system and method for a diesel engine with compression induced ignition, NOₓ emissions are reduced by providing a supplemental fuel injection from a supplemental injection nozzle, in addition to the primary fuel injection through a primary injection nozzle. The supplemental injection nozzle injects a supplemental quantity of fuel onto a vaporization surface such as an exhaust valve, a flame ring area, or a top surface of the piston, in the combustion chamber, whereupon the supplemental fuel vaporizes and forms a lean air/fuel mixture. Thereafter, the primary injection nozzle injects the main fuel charge into the combustion chamber, to produce a rich air/fuel combustion mixture, which is then ignited and combusts.

### PRIORITY CLAIM

This application is based on and claims the priority under 35 USC 119 of German Patent Application 10 2012 011 149.5, filed on Jun. 5, 2012, the entire disclosure of which is incorporated herein by reference.

### FIELD OF THE INVENTION

The invention relates to a fuel injection system and method for diesel engines using compression ignition, wherein fuel injection nozzles carry out a controlled injection of fuel into a combustion chamber formed by a piston in a cylinder with controllable inlet and exhaust valves.

### BACKGROUND INFORMATION

In a conventional diesel engine, diesel fuel is injected into the combustion chamber in the cylinder, for example from a fuel injection nozzle located approximately centrally above the combustion chamber in the head of the engine. As the air charge in the cylinder is compressed during the compression up-stroke of the piston, the compression causes the air to be heated to a high temperature, which is sufficiently high to cause spontaneous compression-induced ignition of the injected fuel. However, due to the high temperature during the combustion in such diesel engines, various nitrogen oxide NOₓ compounds are produced as combustion byproducts, and are emitted in the exhaust gas. The higher the combustion temperature, the higher the proportion of nitrogen oxide NOₓ emissions will be. Such NOₓ emissions are undesirable as they include poisonous compounds and contribute to pollution of the atmosphere. In order to reduce or limit the formation and thus the emission of NOₓ, it is desirable to carry out the combustion with a lean air/fuel mixture, i.e. by providing excess air beyond the minimum air ratio needed for combustion of the fuel. Nonetheless, even if an excess quantity of air is provided in relation to the injected fuel quantity overall, due to the formation of a heterogenous mixture in the case of diesel combustion, as a result certain zones will arise in the combustion chamber in which the combustion progresses stoichiometrically, i.e. in the exact air/fuel ratio for stoichiometric combustion, without excess air. For this reason, a constant pressure combustion with excess air in principle results in higher NOₓ emissions than a constant volume combustion process with formation of a homogenous air/fuel mixture.

In order to limit the formation of NOₓ combustion byproducts in the case of a diesel combustion, it is thus necessary to try to achieve a homogenous air/fuel mixture and a corresponding homogenous combustion. Simultaneously, it is also necessary that fuel in liquid form must be injected into the combustion chamber during the combustion, in order to further obtain or maintain the advantages of the diesel combustion process. According to the present state of the art, the above two goals or objects are directly in conflict with one another, because in conventional fuel injection systems, the injection of diesel fuel very early during the compression stroke causes a detonation-like combustion known as “diesel knock”, which can lead to mechanical damage of the engine.

### SUMMARY OF THE INVENTION

In view of the above, it is an object of the invention to further develop and modify a fuel injection system of the above described general type, which provides a combination of components and/or features to achieve a lean air/fuel mixture with a thorough vaporization of the injected diesel fuel for forming a relatively homogenous air/fuel mixture, and ensures a reliable ignition injection of diesel fuel, in order to reduce or limit the a formation of NOₓ emissions. It is a further object of the invention to enable the injection of distinct fuel quantities at distinct time points within the engine cycle and at distinct locations within the combustion chamber, in order to improve the homogenous combustion and reduce or limit the formation of NOₓ emissions. Another object of the invention is to provide a supplemental fuel injection nozzle in addition to the (e.g. conventional) primary fuel injection nozzle, by which combination of nozzles the improvements being strived for can be achieved. The invention further aims to provide both a system or apparatus as well as a method with respective combinations of features for achieving the desired goals. The invention further aims to avoid or overcome the disadvantages of the prior art, and to achieve additional advantages, as apparent from the present specification. The attainment of these objects is, however, not a required limitation of the claimed invention.

The above objects have been achieved according to the invention in a fuel injection system for a diesel engine with compression ignition, having a combustion chamber formed in a cylinder bounded by a piston moving in the cylinder, and with controllable inlet and exhaust valves, as well as a primary fuel injection is nozzle. According to the invention, an additional supplemental fuel injection nozzle is provided. The supplemental injection nozzle is controllable independently of the primary injection nozzle. The supplemental injection nozzle is preferably arranged in an upper wall or boundary area of the combustion chamber, for example especially in an upper area of the cylinder near the cylinder head, or in a portion of the cylinder head bounding the upper end of the cylinder. The supplemental injection nozzle has a fixed or adjustable fuel injection angle so as to inject a supplemental quantity of diesel fuel into or onto a boundary area and especially preferably a hot vaporizing surface of the combustion chamber that has a prevailing component temperature above the boiling temperature of the diesel fuel. To carry out the combustion process, first a supplemental quantity of diesel fuel is injected via the supplemental injection nozzle onto the hot vaporizing surface, to vaporize the fuel and produce a homogenous lean air/fuel mixture below a self-ignition limit. After the conditions of temperature and pressure within the combustion chamber have changed due to further compression by the piston's further up-stroke, then the primary combustion quantity of diesel fuel is injected via the primary fuel injection nozzle in order to initiate the compression-induced combustion.

In further preferred embodiments of the invention, the injection angle of the supplemental injection nozzle is oriented so as to direct the injected supplemental quantity of diesel fuel into contact with one or more hot vaporizing surfaces within the combustion chamber, for example an exhaust valve, an area on the crown or top surface of the piston, or an area of the flame ring in the top area of the cylinder adjoining the cylinder head. The “injection angle” refers to the orientation of the central axis of the injection spray pattern, e.g. the central axis of the injection spray cone, or refers to the angular width of the spray pattern sufficient to impinge fuel onto the stated surfaces. Through the contact of the diesel fuel with such a hot vaporizing surface, this causes a reliable vaporization of the fuel and thus the formation of a homogenous mixture of the vaporized fuel with the air present in the combustion chamber. The supplemental quantity of fuel is limited, however, so that there is an extreme excess air quantity in the resulting homogenous mixture. Due to the prevailing extreme air excess as well as the relatively low temperature level in the combustion chamber at the time of the supplemental injection, this lean homogenous air/fuel mixture does not self-ignite. Thereby, the NOₓ components formed during the subsequent combustion can be reduced.

Furthermore, the non-ignitable homogenous air/fuel mixture present in the combustion chamber can reduce the temperature level in the combustion chamber. Particularly, the supplemental injected fuel serves to cool the particular “hot spot” within the combustion chamber at which the supplemental injected fuel is directed, e.g. the exhaust valve, the flame ring area, or the top surface of the piston. As further alternatives, the supplemental injected fuel may be directed at any combination of two or more of these areas, for example especially at the flame ring area and the exhaust valve, or at the flame ring area and the piston top surface, or at the exhaust valve and the piston top surface. This cooling can help to avoid the occurrence of detonation or diesel knock, for example.

Then, following the supplemental injection, the normal primary injection of fuel necessary for ignition and combustion is carried out, for example in a conventional manner. The primary injected fuel mixes into the homogenous lean air/fuel mixture already established in the combustion chamber by the supplemental injected fuel. The compression up-stroke of the piston has continued in the meantime between the supplemental fuel injection and the primary fuel injection, thereby increasing the temperature and the pressure in the combustion chamber, which then leads to the smooth homogenous ignition and combustion of the resultant air/fuel mixture including both the supplemental injected fuel and the primary injected fuel.

In order to ensure an optimized vaporization of the supplemental injected fuel, the selected vaporization surface at the time of the first injection, i.e. the supplemental injection via the supplemental injection nozzle, shall have a temperature in a range from 200° C. to 500° C., and especially preferably in a range from 200° C. to 350° C. The target injection area is thus selected appropriately based on the operating temperatures at different areas within the combustion chamber.

Furthermore, to suitably control the supplemental injection, the supplemental injection nozzle preferably has an adjustable spray angle and/or an adjustable injection angle and/or an adjustable nozzle orifice diameter. Furthermore, a plurality of such supplemental injection nozzles can be arranged at different locations and/or with different injection angles.

As discussed above, the supplemental fuel injection via the one or more supplemental injection nozzles is preferably carried out after closing the inlet valve and before the beginning of the main or primary fuel injection via the primary fuel injection nozzle. In particular preferred embodiments, the supplemental fuel injection shall take place between 10° CA aBDC and 40° CA aBDC, and especially between 17° CA aBDC and 23° CA aBDC in typical diesel engines operating according to a typical diesel cycle, or between 80° CA bBDC and 40° CA aBDC in diesel engines operating according to a Miller cycle or an Atkinson cycle. After the supplemental injection, the primary fuel injection for the ignition is carried out via the primary injection nozzle at a time point between 20° CA bTDC and 0° CA bTDC. As is conventionally known in the above expressions, “CA” means “crankshaft angle”, “a” means “after”, “b” means “before”, “BDC” means “bottom dead center” and “TDC” means “top dead center” regarding the travel of the piston as linked to the rotation angle of the crankshaft. Thus, for example, “aBDC” means “after bottom dead center” and “bTDC” means “before top dead center”.

### BRIEF DESCRIPTION OF THE DRAWINGS

In order that the invention may be clearly understood, it will now be explained in further detail in connection with example embodiments thereof, with reference to the accompanying drawings, wherein:

FIG. 1 is a schematic sectional illustration of a cylinder of a diesel engine, including a primary fuel injection nozzle and an additional supplemental fuel injection nozzle arranged to inject fuel at an exhaust valve, according to the invention;

FIG. 2 is a sectional illustration similar to FIG. 1, but showing a second embodiment in which the supplemental injection nozzle directs injected fuel at a flame ring;

FIG. 3 is another sectional illustration similar to FIG. 1, but showing a third embodiment in which the supplemental injection nozzle directs injected fuel at a crown or top surface of a piston;

FIG. 4 is a sectional illustration similar to FIGS. 1 to 3, but showing a subsequent time point at which the primary injection nozzle is activated to inject the primary combustion fuel after the supplemental injection nozzle has injected the supplemental fuel; and

FIG. 5 is a pressure-volume diagram schematically representing a theoretical diesel engine combustion process for constant volume and constant pressure combustion, illustrating particularly the pressure and volume conditions for the supplemental fuel injection according to the invention.

### DETAILED DESCRIPTION OF PREFERRED EXAMPLE EMBODIMENTS AND THE BEST MODE OF THE INVENTION

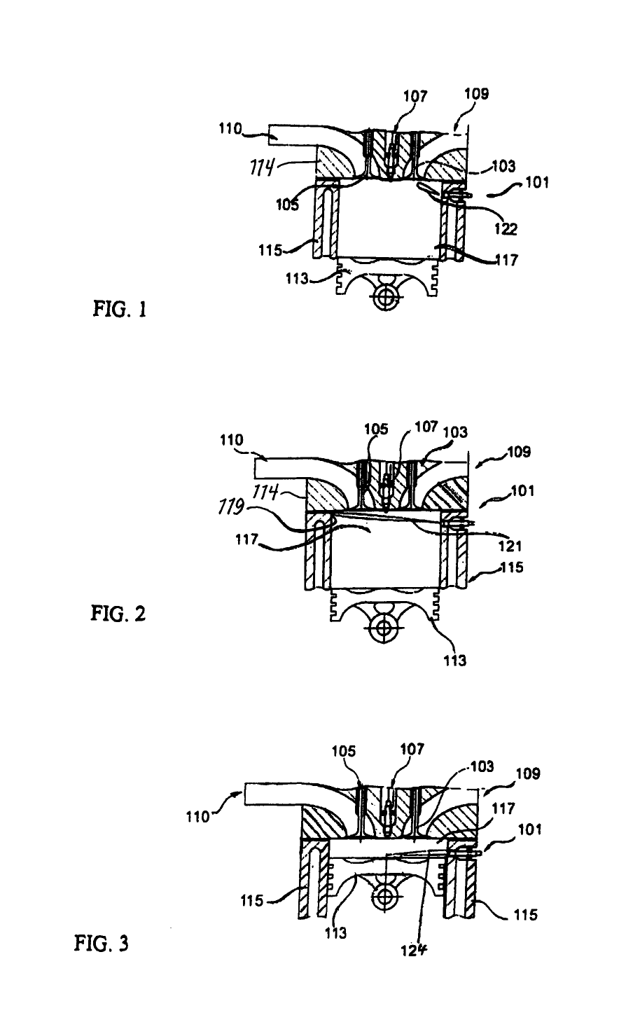

FIGS. 1 to 4 schematically represent a cross-section through a single cylinder of a diesel engine that has been equipped or modified according to the invention. Particularly, the arrangement includes a piston 113 movably arranged in a cylinder 115, and a cylinder head 114 connected to the open top of the cylinder 115 via a flame ring 119, or the flame ring is provided in the cylinder near the top end thereof adjacent to the head. Thus, a combustion chamber 117 is formed within the cylinder, namely bounded within the walls of the cylinder 115 between the movable piston 113 and the cylinder head 114. When referring to the “cylinder” herein, this term may include both the cylinder walls and the cylinder head.

An air inlet opening or passage 110 and an exhaust outlet opening or passage 109 are provided in the cylinder head 114. The inlet passage 110 and exhaust passage 109 are respectively equipped with a controlled inlet valve 105 and a controlled outlet valve 103, whereby the respective passages are opened and closed in a controlled manner during the operating cycle of the piston 113 in the cylinder 115. Such valves and the control arrangement for controlling the valves can be according to any conventional known teachings in addition to the teachings herein.

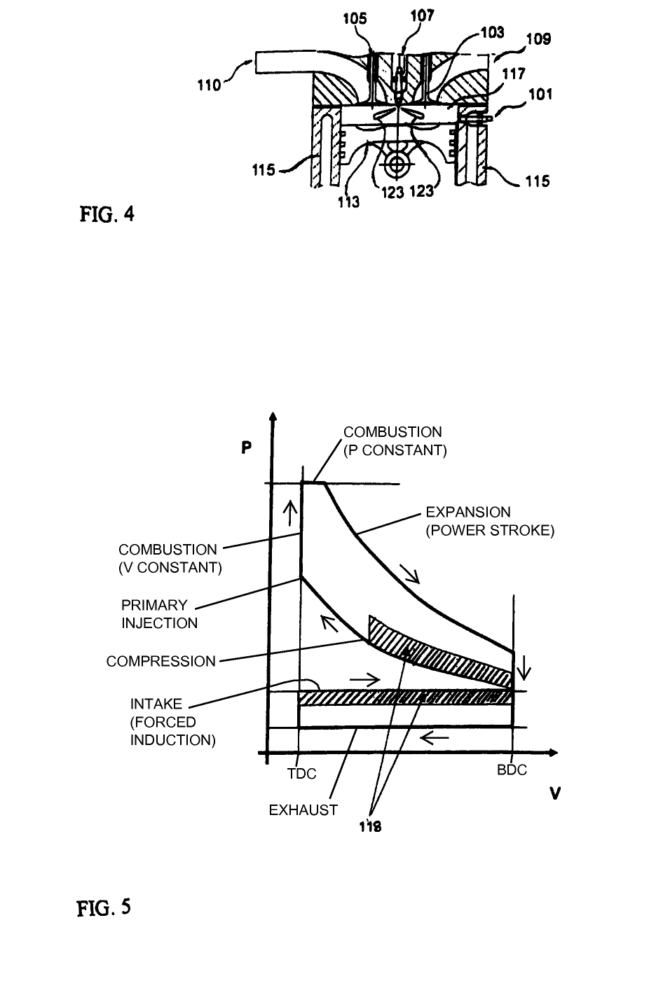

Further, a primary fuel injection nozzle 107 is fitted in the cylinder head 114, for example arranged approximately centrally axially at the top of the combustion chamber 117 in the cylinder 115. The primary injection nozzle 107 is thus oriented axially downwardly to inject the primary fuel 123 for combustion into the combustion chamber 117 as will be described below in connection with FIG. 4. This primary injection nozzle may be arranged and may operate according to any conventional known teachings in addition to the teachings herein.

According to the invention, the engine is further equipped with at least one supplemental fuel injection nozzle 101, which is arranged to inject supplemental fuel at particular beneficial locations in the combustion chamber. In the illustrated embodiments, the supplemental fuel injection nozzle 101 is arranged in the sidewall of the cylinder 115 near the top of the combustion chamber 117, for example at or near the top dead center (TDC) position of the piston 113. In the example embodiment of FIG. 4, the supplemental injection nozzle 101 is arranged essentially flush with the top of the piston 113 at a piston position of 18° CA (crank shaft angle) bTDC (before top dead center). The supplemental fuel injection nozzle 101 is flush with or sufficiently recessed into the wall of the cylinder 115 so that the piston 113 can pass upwardly beyond the nozzle 101 without collision.

The supplemental injection nozzle 101 has its nozzle body oriented substantially at 90° relative to the axis of the primary injection nozzle 107, and sprays or injects the supplemental fuel charge laterally into the combustion chamber 117. The injection angle of the nozzle orifice, i.e. the direction of the central axis of the fuel injection pattern of the nozzle 101, or the angular range of the spray pattern, is either fixed or adjustable so as to direct the supplemental fuel injection spray at particular locations within the combustion chamber, as follows. In the embodiment according to FIG. 1, the supplemental fuel injection nozzle 101, or particularly its nozzle orifice, is oriented particularly so as to direct the fuel injection spray 122 onto the exhaust valve 103. In the second embodiment according to FIG. 2, the supplemental injection nozzle 101 is oriented so as to direct the supplemental fuel injection spray 121 onto the area of the flame ring 119 substantially across the combustion chamber 117 from the location of the nozzle 101. In the third embodiment according to FIG. 3, the supplemental fuel injection nozzle 101 is oriented so as to direct the supplemental fuel injection spray 124 onto the top surface of the piston 113 when the piston is at a position just under the height of the nozzle 101. The three supplemental fuel injection patterns or directions as represented in FIGS. 1, 2 and 3 can be achieved respectively by three different supplemental injection nozzles, having three different fixed injection angles in three different embodiments, or can be achieved by suitably adjusting the injection angle of the same single supplemental injection nozzle 101 to the orientations shown in FIGS. 1, 2 and 3.

A representative sequence of a combustion process in the engine with the fuel injection system according to the invention will now be described. FIGS. 1 to 4 represent various positions of the piston during its compression up-stroke in different embodiments of the invention. Thus, the inlet valve 105 and exhaust valve 103 are closed, and a fresh air charge in the combustion chamber 117 is being compressed by the upward stroke of the piston 113. Then, as a first part of the fuel injection process, the supplemental injection nozzle 101 is activated to inject supplemental fuel into the combustion chamber 117, e.g. onto the exhaust valve 103 as shown in FIG. 1, and/or onto the flame ring area 119 as shown in FIG. 2, and/or onto the top surface of the piston 113 as shown in FIG. 3. Thereby FIGS. 1 to 3 represent three different embodiment possibilities, or represent three different fuel injections taking place in a single embodiment e.g. with three supplemental fuel injectors at different locations in the cylinder wall. The position of the piston during these supplemental fuel injection steps is generally as represented in the figures, or particularly within the angular ranges of the piston position as disclosed above.

Namely, instead of just a single vaporizing surface, it is alternatively possible to inject respective sprays of supplemental fuel from one or more supplemental injection nozzle(s) 101 onto all three of the exhaust valve 103, the flame ring area 119 and the surface of the piston 113, or any selected combination of two of these vaporizing surfaces. This can be achieved by adjusting the injection angle of an adjustable nozzle 101, or providing a plurality of nozzles 101, or providing a single nozzle 101 that has an injection spray pattern directed at more than one target vaporizing surface. The selected target location(s) at which the supplemental fuel is directed, e.g. the exhaust valve 103, the wall of the flame ring 119, and/or the top surface of the piston 113, are considered to be vaporizing surfaces because they are typically heated to a temperature of about 230° C. during the operation of the diesel engine. As a result of this elevated temperature, the injected supplemental fuel completely vaporizes when striking and/or approaching the respective vaporizing surface. This vaporized fuel mixes into the air charge in the combustion chamber 117 and produces a homogenous lean air/fuel mixture with an excess air ratio or proportion of about 3.2 times the minimum necessary air quantity for combustion of the diesel fuel. At this time, the piston position is approximately 20° CA aBDC (after bottom dead center) as shown in FIGS. 1 and 2, or later as shown in FIG. 3. Because the resulting mixture is very lean, and in view of the relatively low pressure and temperature existing at the time of the supplemental fuel injection, this lean supplemental air/fuel mixture does not self-ignite.

Thereafter, when the piston 113 has traveled farther upwardly to the position shown in FIG. 4, in the present example being the piston position at 18° CA bTDC, then the primary injection nozzle 107 is activated in order to inject the primary diesel fuel injection spray 123 into the combustion chamber 117. The injected primary fuel 123 mixes into the previously achieved lean air/fuel mixture to produce a rich ignitable combustion mixture with an air ratio or proportion of about 1.3. Once sufficient compression and thus sufficient temperature have been achieved, due to the progressing up-stroke of the piston 113 and consequent further reduction of the volume of the combustion chamber 117, the total or final rich air/fuel combustion mixture ignites and fully combusts in the combustion chamber 117. As a result, this drives the piston 113 downwardly in its power stroke.

The primary injection nozzle 107 and the supplemental injection nozzle 101, as well as the valves 103 and 105, can be controlled by a control arrangement (not shown) that is adapted, configured, arranged and connected to the controlled components so as to achieve the control as described herein. The control arrangement may include one or more cooperating conventionally known valve and/or injector controllers, which may have any known construction and operation, e.g. with electronic, electric, electro-mechanical, mechanical, pneumatic, and/or hydraulic components, controlled by mechanical linkages, hardware, firmware and/or software, so as to carry out the control according to the invention as disclosed herein.

When adding the supplemental fuel injection according to the invention, the quantity of fuel injected for the primary injection can be maintained the same as without a supplemental fuel injection, or can be adjusted as desired. If the primary injection quantity is maintained the same as it would be without the supplemental injection, then adding the supplemental injection results in an increased fuel charge and thus greater power produced during the combustion and output during the power stroke of the piston. If the air quantity remains the same, then the air/fuel mixture will be richer as discussed above. Alternatively, the primary fuel injection quantity can be reduced as desired, so that the total fuel quantity (primary plus supplemental) is less than, equal to or greater than the normal fuel quantity that would have been injected by the primary injector without the inventive modification. This preferably results in a rich final air/fuel mixture as mentioned above. The extent or proportion of enrichment, e.g. the air/fuel ratio, can be adjusted as desired by adjusting the quantity of fuel for the supplemental injection and/or the quantity of fuel for the primary injection.

It should be understood that a “lean combustion mixture” generally refers to an air/fuel mixture in which the air quantity or proportion is greater than the air proportion that is minimally necessary for combustion of the fuel. Particularly, a lean combustion mixture exists if the air proportion amounts to about 1.5 to 5 times the minimum necessary air proportion for combustion. On the other hand, a “rich combustion mixture” exists if the air proportion in the mixture is smaller than the air proportion that is minimally necessary for combustion of the fuel. Particularly, a rich combustion mixture exists when the air proportion is below 1.5 times the minimum necessary air proportion. For diesel fuel combustion, the necessary air proportion is about 14.2 kg of air per 1 kg of diesel fuel.

FIG. 5 is a schematic pressure-volume diagram of a modified diesel combustion cycle in a representative example utilizing a supplemental fuel injection according to the invention together with a primary fuel injection. The diagonally hatched regions 118 represent modifications according to the invention by adding a supplemental fuel injection. The diagonally hatched region on the compression stroke indicates that the supplemental fuel injection can take place in this range of piston travel or position during the compression stroke. The other diagonally hatched region extends along all of the intake stroke with a positive-pressure forced induction, e.g. with a turbocharger or supercharger. Namely, a supplemental fuel injection can take place any time during this forced induction intake stroke. In the example shown in this diagram, the pressure of the forced induction during the intake stroke is greater than the pressure prevailing in the cylinder during the exhaust stroke. The relative pressures during the intake and exhaust strokes depend on the forced induction boost pressure, the valve restrictions of the intake and exhaust valves, the exhaust system restriction or back pressure, and other factors, so that the actual pressures prevailing during the intake stroke and the exhaust stroke may have other values than shown, and may be relatively reversed from the situation shown as an example in FIG. 5. The preferred ranges of piston position or travel, in terms of the crankshaft angle, during which the supplemental injection and the main injection shall take place, have been set forth above. FIG. 5 merely schematically represents an example.

References to directions such as “top” refer to the orientation of a cylinder according to FIGS. 1 to 4, but it should be understood that the cylinder can be tipped to any other angle or inverted, without detracting from the invention. Thus, the terms “top”, “upper” etc. are not strict limitations on a mandatory orientation of the engine or its cylinder(s).

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims. The abstract of the disclosure does not define or limit the claimed invention, but rather merely abstracts certain features disclosed in the application.

What is claimed is:

1. A diesel engine with compression ignition, comprising:
a cylinder with a piston movably arranged therein, defining a combustion chamber bounded by said piston in said cylinder;
an inlet valve communicating with said combustion chamber;
an exhaust valve communicating with said combustion chamber;
a primary fuel injection nozzle arranged in said cylinder to inject a primary charge of diesel fuel into said combustion chamber;
a supplemental fuel injection nozzle arranged in said cylinder to inject a supplemental charge of diesel fuel directed onto a hot vaporizing surface in said combustion chamber, wherein said hot vaporizing surface has a temperature above a vaporizing temperature of the diesel fuel during the operation of said diesel engine; and
a control arrangement adapted and arranged to control a supplemental injection of the supplemental charge of diesel fuel by said supplemental fuel injection nozzle to occur at a first time and with a first quantity of said supplemental charge to produce in said combustion chamber an initial air/fuel mixture below a self-ignition limit, and to control a primary injection of the primary charge of diesel fuel by said primary fuel injection nozzle to occur at a second time and with a second quantity of said primary charge to further enrich said initial air/fuel mixture to produce an ignitable air/fuel mixture.

2. The diesel engine according to claim 1, wherein said primary fuel injection nozzle is arranged centrally at a top of said cylinder opposite said piston.

3. The diesel engine according to claim 1, wherein said supplemental fuel injection nozzle is arranged laterally in an upper portion of a cylinder wall of said cylinder.

4. The diesel engine according to claim 1, wherein said hot vaporizing surface is any one of a surface of said exhaust valve, a surface of said piston, or a surface of a flame ring provided in said cylinder.

5. The diesel engine according to claim 1, wherein said hot vaporizing surface includes both a surface of said exhaust valve and a surface of a flame ring provided in said cylinder.

6. The diesel engine according to claim 1, wherein said hot vaporizing surface includes both a surface of said piston and a surface of a flame ring provided in said cylinder.

7. The diesel engine according to claim 1, wherein said hot vaporizing surface includes both a surface of said exhaust valve and a surface of said piston.

8. The diesel engine according to claim 1, wherein said hot vaporizing surface includes a surface of said exhaust valve, a surface of said piston, and a surface of a flame ring provided in said cylinder.

9. The diesel engine according to claim 1, wherein said supplemental fuel injection nozzle has an adjustable injection angle.

10. The diesel engine according to claim 1, wherein said supplemental fuel injection nozzle has an adjustable nozzle orifice diameter.

11. The diesel engine according to claim 1, further comprising a second supplemental fuel injection nozzle arranged in said cylinder to inject a further supplemental charge of diesel fuel directed onto said hot vaporizing surface or another hot vaporizing surface in said cylinder.

12. The diesel engine according to claim 1, wherein said control arrangement is further adapted and arranged to control said inlet valve, such that said supplemental injection occurs after closing said inlet valve and before said primary injection.

13. The diesel engine according to claim 1, wherein said control arrangement is further adapted and arranged such that said first time of said supplemental injection occurs between positions of said piston at 10° CA aBDC and 40° CA aBDC for said diesel engine operating according to a diesel cycle or between positions of said piston at 80° CA bBDC and 40° CA aBDC for said diesel engine operating according to a Miller cycle or an Atkinson cycle, and such that said second time of said primary injection occurs between positions of said piston at 20° CA bTDC and 0° CA bTDC.

14. The diesel engine according to claim 1, wherein said control arrangement is further adapted and arranged such that said first time of said supplemental injection occurs between positions of said piston at 17° CA aBDC and 23° CA aBDC.

15. A method of fuel injection for a diesel engine having a cylinder with a piston movably arranged therein defining a combustion chamber bounded by said piston in said cylinder, an inlet valve, an exhaust valve, a primary fuel injection nozzle, and a supplemental fuel injection nozzle, said method comprising the steps:
a) admitting air into said combustion chamber via said inlet valve;
b) at a first time, using said supplemental fuel injection nozzle, injecting a supplemental fuel charge onto a hot vaporizing surface in said combustion chamber, which causes said supplemental fuel charge to vaporize into said air and form in said combustion chamber an initial air/fuel mixture below a self-ignition limit;
c) at a second time after said first time, using said primary fuel injection nozzle, injecting a primary fuel charge into said combustion chamber so as to enrich said initial air/fuel mixture to produce in said combustion chamber an ignitable air/fuel mixture; and
d) igniting and combusting said ignitable air/fuel mixture in said combustion chamber.

16. The method according to claim 15, wherein said first time occurs during said step a).

17. The method according to claim 15, wherein said first time occurs after said step a), while moving said piston to compress said air in said combustion chamber.

18. The method according to claim 15, further comprising moving said piston, and wherein said first time occurs between positions of said piston at 10° CA aBDC and 40° CA aBDC for said diesel engine operating according to a diesel cycle or between positions of said piston at 80° CA bBDC and 40° CA aBDC for said diesel engine operating according to a Miller cycle or an Atkinson cycle, and said second time occurs between positions of said piston at 20° CA bTDC and 0° CA bTDC.

19. The method according to claim 15, further comprising moving said piston, and wherein said first time occurs between positions of said piston at 17° CA aBDC and 23° CA aBDC.

20. The method according to claim 15, wherein said initial air/fuel mixture is a lean mixture with a proportional content of said air being from 1.5 to 5 times a minimum proportion of air necessary for combustion, and said ignitable air/fuel mixture is a rich mixture with a proportional content of said air being less than 1.5 times the minimum proportion of air necessary for combustion.
